(19) United States
(12) Patent Application Publication
(10) Pub. No.: US 2026/0042161 A1
(43) Pub. Date: Feb. 12, 2026

(54) METHOD FOR CALIBRATING A GEAR-CUTTING MACHINE

(71) Applicant: Liebherr-Verzahntechnik GmbH, Kempten (DE)

(72) Inventors: Hansjoerg GEISER, Kempten (DE); Johannes VAN HAUTH, Kempten (DE)

(21) Appl. No.: 19/292,535

(22) Filed: Aug. 6, 2025

(30) Foreign Application Priority Data
Aug. 6, 2024 (DE) 10 2024 122 379.0

(51) Int. Cl. B23F 23/10; B23F 23/12

(52) U.S. Cl. CPC B23F 23/10; B23F 23/1218

(57) ABSTRACT

A gear-cutting machine comprises a workpiece holder rotatable about a first axis of rotation, a machining head comprising a tool holder, and a sensor arranged on the machining head of the gear-cutting machine for measuring a workpiece that is held in the workpiece holder of the gear-cutting machine. The machining head is displaceable relative to the workpiece holder in the workpiece width direction via a first linear movement axis Z of the gear-cutting machine. The disclosed method comprises ascertaining a first calibration value by measuring the workpiece at a first workpiece width position, ascertaining a second calibration value by measuring the workpiece at a second workpiece width position, and determining a third calibration value for the relative orientation of the first linear movement axis Z of the machining head with respect to the first axis of rotation of the workpiece holder from the first and second calibration value.

### CROSS REFERENCE TO RELATED APPLICATION

The present application claims priority to German Patent Application No. 10 2024 122 379.0 filed on Aug. 6, 2024. The entire contents of the above-listed application are hereby incorporated by reference for all purposes.

### TECHNICAL FIELD

The present disclosure relates to a method for calibrating a gear-cutting machine by measuring a workpiece held in the workpiece holder of the gear-cutting machine.

### BACKGROUND

In the case of gear-cutting machines in which a sensor, in particular in the form of a measuring sensor, is installed, in order to be able to check the produced workpieces in the machine (e.g. tooth thickness check, pitch check, profile check, flank line check), external influences such as temperature fluctuations may lead to minimal deformations in the machine, which make these checks imprecise. The resulting changes in the position of the sensor relative to the toothing therefore have to be regularly ascertained and compensated by calibration, in order to be able to ensure consistently good checking results.

### SUMMARY

The ascertaining of the position of the sensor required for calibration, can be carried out on a measurement object, such as a block gauge. However, ascertaining directly on a workpiece clamped in the machine, in particular a gearwheel, is associated with advantages. In particular, the outlay for the workman, introducing a block gauge (calibration sphere/calibration standard) into the machine and removing it again after the calibration, is omitted. In the case of gear-cutting machines for manufacturing large workpieces, it may also be possible that the displacement paths for the measuring sensors are not sufficient in order to be able to reach a block gauge. This is also prevented by a measurement on the workpiece.

A method for calibrating a measuring sensor in a gear-cutting machine with the aid of a workpiece is known from EP 2 554 938 B1, in which the profile of the workpiece is determined twice by different measuring steps. In the first measuring step, the measuring sensor is displaced in a tangential direction, while the workpiece is rotated, but in the second measuring step, in contrast, in a non-tangential direction, for example radial. A position error of the measuring head is ascertained on the basis of a difference between the tooth profile gradient errors determined in the respective measuring steps and used for calibration.

A method for calibrating a measuring sensor in a gear-cutting machine with the aid of a workpiece is known from DE 10 2019 104 891 A1, in which the centre point of the measuring sensor tip (optionally apart from the measured deviations) is moved on a circular path).

Both methods serve for calibrating an X-axis and V/Y-axis, over which the measuring sensor is displaceable in a plane perpendicular to the axis of rotation C1 of the workpiece holder, and thus for calibrating the position of said axes relative to the axis of rotation C1 of the workpiece holder.

Furthermore, it is known from the prior art to identify and if applicable remedy clamping errors of a workpiece. In these methods, however, it is assumed that all the axes of the gear-cutting machine relative to one another are already calibrated.

In this case, EP 1 319 457 A2 discloses a method for machining gearwheels, in which the workpiece is not aligned exactly on the machining device, therefore in which the wheel guide axis, which is later intended to become the axis of rotation in the gear, does not coincide with the axis of rotation on the machining device, and consequently the wheel guide axis F wobbles around the axis of rotation D in the case of a rotating table or rotating workpiece spindle. In this case, the location of the wheel guide axis F relative to the axis of rotation D on the machining device is determined, in that corresponding flanges on the workpiece are sampled, and the inexact alignment of the workpiece during machining is compensated by additional movements of the axes, such that the toothing is created around the wheel guide axis F. A comparable method is also known from EP 2 596 892 B1, DE 37 12 454 A1 and DE 196 31 620 A1.

EP 1 952 927 A1 discloses a method in which a faulty clamping of the workpiece is corrected by an adjustment device provided on the workpiece holder.

According to EP 3 274 776 B1, a temperature-related change in a characteristic workpiece variable, such as the tooth width, is intended to be compensated by a correction of the delivery.

The object of the present disclosure is that of providing an improved method for calibrating a gear-cutting machine.

This object is achieved by a method as described herein.

The present disclosure comprises a method for calibrating a gear-cutting machine, which comprises a workpiece holder that is rotatable about a first axis of rotation C1, a machining head comprising a tool holder, and a sensor for measuring a workpiece that is held in the workpiece holder of the gear-cutting machine, wherein the sensor is arranged on the machining head of the gear-cutting machine, wherein the machining head is displaceable relative to the workpiece holder in the workpiece width direction via a first linear movement axis Z of the gear-cutting machine, wherein the method comprises the following steps of:
ascertaining at least one first calibration value by measuring a toothing of the workpiece at a first workpiece width position,
ascertaining at least one second calibration value by measuring a toothing of the workpiece at a second workpiece width position, and
determining at least one third calibration value for the relative orientation of the first linear movement axis Z of the machining head with respect to the first axis of rotation C1 of the workpiece holder from the at least one first and the at least one second calibration value.

In this case, the inventors of the present disclosure have identified that ascertaining calibration values at two different workpiece width positions also makes it possible to calibrate the relative alignment of the first linear movement axis Z of the machining head relative to the first axis of rotation C1 of the workpiece holder, wherein in particular a deviation of the two aces from a desired parallel alignment can be recorded. In particular, the at least one third calibration value therefore describes a deviation of the two axes from a desired parallel alignment and/or allows the correction of such a deviation.

Preferred embodiments of the method according to the disclosure are described in the following.

According to a possible embodiment, the first and the second calibration value are ascertained by measuring the same toothing at the first and the second workpiece width position. Alternatively, however, the first and second calibration value can also be ascertained by measuring a first and a second toothing of the workpiece. If, in the following, a toothing is referred to in this case, this also always includes the possibility that two different toothings are measured.

According to a possible embodiment, the gear-cutting machine comprises at least one second linear axis X1 and/or one third linear axis V1/Y1 for displacing the machining head relative to the workpiece holder, wherein the at least one first calibration value and the at least one second calibration value relate in each case to a calibration of the position of the second linear axis X1 and/or of the third linear axis V1/Y1 relative to the first axis of rotation C1. In particular, in this case the first and second calibration values each describe the position of the machining head in a plane perpendicular to the first axis of rotation C1 of the workpiece holder.

According to a possible embodiment, the ascertaining of the calibration values takes place in each case by measuring a toothing of the workpiece created on the gear-cutting machine in the same clamping operation. Measuring a toothing created on the gear-cutting machine ensures that the contour measured is not influenced by clamping errors of the workpiece in the workpiece holder, but rather the axis of rotation of the contour of the workpiece corresponds to the axis of rotation of the workpiece holder.

In contrast, according to an alternative embodiment, the toothing is already present before the workpiece is clamped in the gear-cutting machine, and no machining of the toothing on the gear-cutting machine takes place before the toothing is measured.

However, clamping errors of the workpiece in the workpiece holder cannot be excluded in this case. As a result, during measuring the contact point may be located slightly further inside or outside the evolvent than assumed. In any case for certain embodiments of the present disclosure, however, this has no significant influence on the determination of the calibration values.

Preferably, however, the toothing is machined before the measuring, either in another clamping operation, for example on another gear-cutting machine, or in the same clamping operation, in order to provide a surface of the toothing. In particular, the toothing is preferably hard-fine machined, in order to prevent advancement markings of a preceding soft machining from negatively influencing the calibration.

According to a possible embodiment, the ascertaining of the at least one first and second calibration value takes place in each case by ascertaining at least one relative position, determined via the sensor, between the workpiece and the machining head at at least one measuring point, wherein the ascertained result is compared with a target relative position, in order to determine therefrom a correction value. This is a correction value of the position of the machining head relative to the axis of rotation C1 of the workpiece holder, in a plane extending perpendicularly to the axis of rotation C1.

According to a possible embodiment, the ascertaining of the at least one first calibration value and of the at least one second calibration value takes place in that the workpiece is rotated, for the measurement, about the axis of rotation C1 of the workpiece holder, and the sensor is displaced via at least one axis of the gear-cutting machine in order to measure the toothing.

According to a possible embodiment, in this case the sensor, for measuring the workpiece, is guided on at least one predetermined path with respect to a point on the workpiece surface. In particular, the path can in any case be predetermined in part by an expected movement of the point on the workpiece surface in the case of a rotational movement of the workpiece about the axis of rotation of the workpiece holder C1.

In this case, according to a first variant, a measuring point of the sensor can be guided in two measurement runs along two different paths along the surface of the toothing, and the first or second calibration value are determined from deviations between the measurement results. In particular, in this case, in the first measurement run the measuring sensor can be displaced in a tangential direction, while the workpiece is rotated, but in the second measurement run, in contrast, in a non-tangential direction, for example radial. A position error of the machining head is ascertained on the basis of a difference between the tooth profile gradient errors determined in the respective measurement runs and used for determining the first and second calibration value. This can in particular take place as is described in EP 2 554 938 B1.

According to a second variant, the sensor is displaced such that a measuring point on the tooth flank would remain unchanged in the case of perfect calibration, wherein the first or second calibration value are determined from deviations between a displacement movement of the sensor expected in the case of perfect calibration and/or a sensor value expected in the case of perfect calibration, and an actual displacement movement of the sensor and/or an actual sensor value in the determination. In particular the machining head, with the sensor, therefore moves (possibly apart from the measured deviations) on a circular path about the axis of rotation C1.

According to a possible embodiment, a measuring sensor can be used as the sensor.

According to a first embodiment of the second variant, the determination of the first and/or second calibration value takes place in each case by means of the following steps of:
displacing the measuring sensor and/or workpiece into a relative position in which the measuring sensor tip touches a tooth flank of the workpiece;
rotating the workpiece about an axis of rotation of the workpiece holder and displacing the measuring sensor via the second and third linear movement axes of the gear-cutting machine such that
   the contact point of the measuring sensor tip on the tooth flank would remain unchanged in the event of perfect calibration, and
   the deflection or the magnitude of the deflection of the measuring sensor tip would assume and/or maintain at least one predetermined value in the event of perfect calibration;
determining a deviation of the deflection of the measuring sensor tip from the at least one predetermined value at at least one measuring point;
determining the at least one first or second calibration value on the basis of the deviation.

According to a second embodiment of the second variant, the determination of the first and/or second calibration value takes place in each case by means of the following steps of:
displacing the measuring sensor and/or workpiece into a relative position in which the measuring sensor tip touches the tooth flank of the workpiece;
rotating the workpiece about an axis of rotation of the workpiece holder and displacing the measuring sensor via the second and third linear movement axes of the gear-cutting machine such that
   the contact point of the measuring sensor tip on the tooth flank would remain unchanged in the event of perfect calibration, and
   the deflection or the magnitude of the deflection of the measuring sensor tip assumes and/or maintains at least one predetermined value;
determining a deviation between the actual position of the axis of rotation of the workpiece holder and/or of the at least two movement axes of the gear-cutting machine from a position which these would occupy in the case of perfect calibration, at at least one measuring point; and
determining the at least one first or second calibration value on the basis of the deviation.

In particular, the determination of the first and/or second calibration value can in each case take place by a method as is described in DE 10 2019 104 891 A1.

The sensor may also be a measuring sensor irrespective of the specifically used method for determining the first and/or second calibration value.

According to a possible embodiment, the third calibration value is consulted, in a subsequent measurement and/or machining, for correcting the displacement kinematics of the machining head and/or for correcting the measurement and/or actuation values.

Therefore, according to a first possible embodiment, in the case of a subsequent measurement and/or machining, during displacement of the machining head along the first linear axis Z depending on the position in the workpiece width direction, the second linear axis X and/or the third linear axis V/Y is also displaced depending on the third calibration value.

According to a second possible embodiment, in the case of a subsequent measurement and/or machining a target flank line angle that is measured and/or on which the actuation is based is corrected depending on the third calibration value, in particular via an offset that is dependent on the calibration value. As a result, the method can also be implemented on a conventional controller, without any change in the actuation of the movement axes of the gear-cutting machine.

According to a possible embodiment, the calibration takes place before a machining step is carried out on the workpiece between two machining steps on the workpiece, or after a machining step has been carried out on the workpiece. In particular, in this case, the correction of the machining on the basis of the third calibration value can be carried out before the last machining step of the workpiece, in particular before the final finishing cut, such that errors in the alignment of the axis of rotation C1 and the first linear axis Z1 do not affect the machining quality.

In contrast, according to a possible embodiment, the calibration takes place only after the machining of a workpiece. The correction can then enter into the measurement of this or further workpieces and/or into the machining of further workpieces.

According to a possible embodiment, the calibration for determining the at least one third calibration value takes place at three or more workpiece width positions. In this way, the precision in the determining of the at least one third calibration value can be increased. In this case, the at least one third calibration value can be determined by interpolation over the values resulting from the three or more calibration positions, or in the form of a calibration curve that is dependent of the position in the workpiece width direction.

The present disclosure further comprises a gear-cutting machine, which comprises a workpiece holder that is rotatable about a first axis of rotation C1, a machining head comprising a tool holder, and a sensor for measuring a workpiece that is held in the workpiece holder of the gear-cutting machine, wherein the sensor is arranged on the machining head of the gear-cutting machine, wherein the machining head is displaceable relative to the workpiece holder in the workpiece width direction via a first linear movement axis Z of the gear-cutting machine, wherein the gear-cutting machine comprises a controller which is configured and/or programmed to carry out a method, as described above, on the gear-cutting machine. In particular, the controller performs the individual steps of the method automatically and/or has operator guidance for performing the steps.

The controller preferably comprises a microcontroller and a software programme, stored on a non-volatile memory, for the control of a gear-cutting machine comprising commands which carry out a method, as described above, on the gear-cutting machine, when executed on the microcontroller. The controller is preferably communicatively connected to the sensor and the movement axes of the gear-cutting machine and actuates the movement axes of the gear-cutting machine and evaluates the signals of the sensor.

The present disclosure furthermore comprises a software programme for the control of a gear-cutting machine comprising commands which carry out a method, as described above, on the gear-cutting machine, when executed on the microcontroller.

In particular, actuated by the software programme, the gear-cutting machine performs the individual steps of the method automatically and/or has operator guidance for performing the steps.

### BRIEF DESCRIPTION OF THE FIGURES

The present disclosure will now be explained in more detail with reference to embodiments and drawings, in which:

FIG. 1 shows an embodiment of a gear-cutting machine according to the disclosure,

FIG. 2 shows an embodiment for a machining head, comprising a sensor, inserted in a gear-cutting machine,

FIG. 3 is a schematic view of an embodiment of the method according to the disclosure, wherein the circular path is shown on which the contact point between the measuring sensor tip and tooth flank should extend in the case of rotation of the workpiece axis of rotation and synchronous displacement of the measuring sensor,

FIG. 4: is a perspective view of a workpiece, in which the measurement of the toothing of the workpiece in three different workpiece width positions is shown,

FIG. 5: is a schematic view of the calculated contact point (41, 41′) and of the actual course of the contact point when position errors (43, 43′) of the measuring sensor tip with the tooth flank are present, at two different workpiece width positions,

FIG. 6: is a schematic view of the relative position between a flank of the toothing and the sensor in the case of a first linear movement axis Z of the gear-cutting machine that is tilted relative to the axis of rotation C1 of the workpiece holder and/or the first and/or second calibration values dV (or dY) that result in each case at a workpiece width position Z, and

FIG. 7: shows a table with first and second calibration values, which were ascertained at three different workpiece width positions, and two graphs which show the determination of the third calibration values from the first and second calibration values.

### DETAILED DESCRIPTION

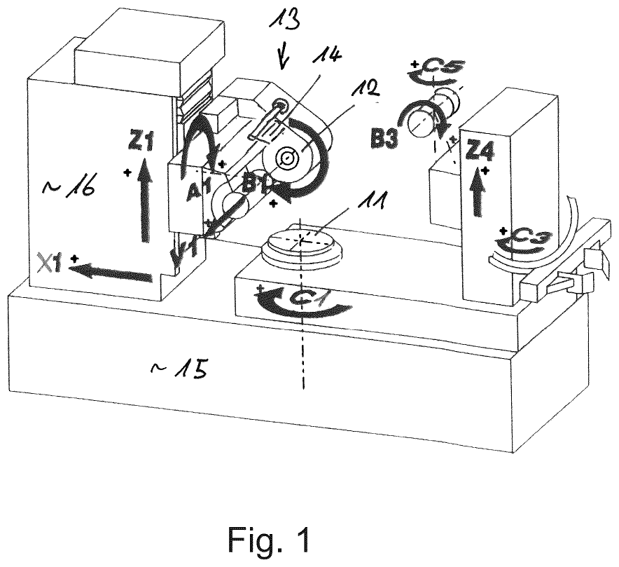

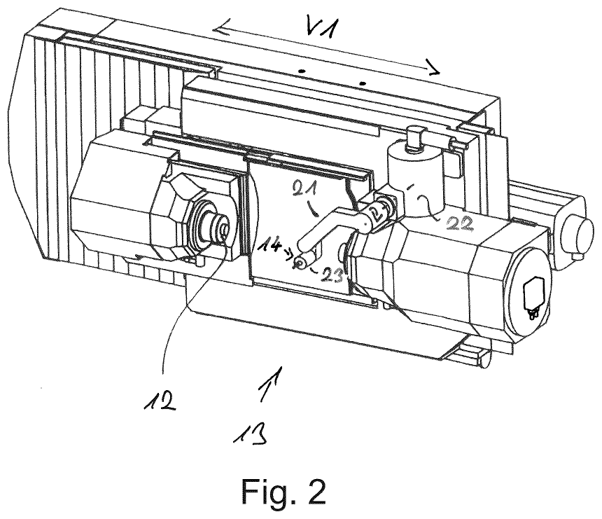

An embodiment for the structure and the mode of operation of a gear-cutting machine according to the disclosure is shown in FIG. 1. FIG. 2 shows an embodiment for a machining head 13, comprising a measuring sensor 14, that can be inserted into the gear-cutting machine.

In the embodiment, the gear-cutting machine comprises a workpiece holder 11 and a tool holder 12. The workpiece and tool holders can be driven via corresponding drives about their axes of rotation C2 and B1, respectively.

The tool holder is arranged on a machining head 13 which is displaceable relative to the workpiece holder via movement axes. In the embodiment, a first linear axis Z1 is provided, via which the tool holder 12 can be displaced in a direction which, in the case of perfect calibration, extends in parallel with the axis of rotation C1 of the workpiece holder. Furthermore, a second linear axis X1 is provided, via which the tool holder 12 can be displaced in a direction which is perpendicular to the axis of rotation C1 of the workpiece holder, in order to change the axial spacing. Furthermore, a third linear axis V1 is provided, via which the tool holder 12 can be displaced in a direction in parallel with its own axis of rotation B1. The alignment of the linear axis V1 and the tool holder 12 can be changed via pivot axis A1 which extends in parallel with the X1 axis.

In the embodiment, the workpiece holder 11 is arranged on a tool bench 15. The machine bed 15 carries a tool stand 16 which is linearly displaceable by means of the X1 axis. A carriage that is displaceable via the axis Z1 is arranged on the tool stand, on which carriage the machining head with the tool holder 12 is arranged via the A1 axis and the V1 axis.

The gear-cutting machine can for example be a gear hobbing machine and/or a gear grinding machine. However, the present disclosure can also be used for any other gear-cutting machines.

FIG. 2 shows an embodiment for a machining head 13. A measuring sensor 14 is arranged thereon as a sensor. Said measuring sensor comprises a measuring sensor base 23, wherein the deflection of a measuring sensor tip of the measuring sensor 14 relative to the measuring sensor base 23 can be determined via at least one sensor.

The measuring sensor 14 is arranged, via the measuring sensor base 23, on a swivel arm 21, which is pivotable via a drive 22 out of an idle position into a measuring position and back.

The definition of the directions X, Y and Z selected in the context of the present description can also be found in FIG. 1, wherein Z is orthogonal to X and Y, such that the three axes form a right-angle system. In the case of perfect calibration, the Z axis extends in parallel with the axis of rotation of the toothing (workpiece axis of rotation). In this case, the C1 axis of the machine denotes an axis of rotation of the workpiece holder, which rotates the workpiece about the workpiece axis of rotation. The X, Y and Z axes denote machine aces which displace the measuring sensor relative to the toothing in the directions X, Y and Z. In this case, the axes do not necessarily have to be physical axes. Thus, the movements can also be implemented by interpolation of two or more axes.

In particular, a movement in the X direction in the embodiment can be achieved via the X1 direction, a movement in the Y direction in the embodiment in a position of the A1 axis in which the V1 axis is in parallel with the Y direction can be achieved via the V1 axis alone, and in other positions by a superimposition of movements of the V1 axis and the Z1 axis. In alternative embodiments of the gear-cutting machine, however, a Y1 axis may also be provided, which is always aligned in parallel with the Y direction, for example in that the Y1 axis carries the A1 axis and is therefore not pivoted thereby.

The measuring sensor tip 1 at the end of the tracer pin 2 of the measuring sensor 14 is preferably a sphere (measuring sensor sphere), for example a ruby sphere.

However, the present disclosure can also be used for other embodiments of the gear-cutting machine or of the sensor.

When ascertaining the first and second calibration values (sensor on workpiece), in each case the relative position between the workpiece and the machining head in a plane perpendicular to the axis of rotation C1 of the workpiece holder is ascertained. The measuring sensor for calibrating is mounted as illustrated above on the same point/axis on which the machining tool would also be mounted. The ascertained result can be compared with a target position and this results in a calibration value, for example in the form of an offset (in the x and y/v direction) which can be added to the actual position. As a result, the selected position corresponds to the target position on the machine, which can be used both during machining and in the case of a measurement/toothing check, in the machine.

According to the prior art, a calibration of this kind takes place only at one position in the workpiece width. If, however, the Z1 axis, the C1 axis (or both) are now not positioned perpendicularly on the X direction or Y direction, but rather inclined in a (different) direction and therefore are no longer in parallel, the relative position between the workpiece and tool/sensor changes over the workpiece width.

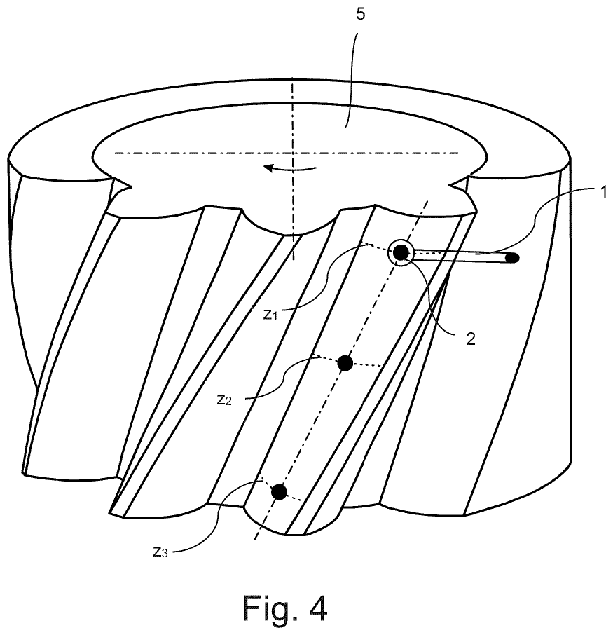

If calibration is now performed at at least two different workpiece width positions z₁ and z₂, different first and second calibration values (in the x and y/v direction) result for the different first and second workpiece width positions z₁ and z₂. The measurement and determination of calibration values can also take place at more than two workpiece width positions, in order to increase the accuracy. In this case, FIG. 4 shows the measuring of the toothing of the workpiece 5 at three different workpiece width positions z₁ to z₃.

According to the disclosure, a third calibration value for the tilt between the C1 axis and the Z1 axis can then be determined from the at least two calibration values for different workpiece width positions.

According to the disclosure, a calibration at different workpiece width positions on the toothing of a workpiece thus takes place, in order to determine the tilt between the C1 axis and the Z1 axis form the calibration values ascertained in this case.

The workpiece is preferably machined on the machine, in order to provide the toothing, before the calibration values are determined. This guarantees that the axis of rotation of the workpiece corresponds to the axis of rotation C1 of the workpiece holder. This procedure furthermore means that axial tilts between the Z1 and the C1 axis of the machine also appear in the workpiece. In the case of tilts in the X direction, the workpiece is conical, in the case of tilts in the V direction it changes (for small angles) in approximately of the pitch height.

However, the method according to the disclosure can also be used for workpieces which were processed on another machine or in another clamping operation, since neither the exact radial runout of the workpiece nor the fact that the tilts between the Z1 and C1 axis are reflected in the workpiece are of importance for carrying out the method according to the disclosure. Rather, when ascertaining the first and second calibration values, in each case the spacing of the sensor and thus of the Z1 axis from the C1 axis of the machine is determined, and thus a calibration between the machine axes is performed, for which clamping errors of the workpiece in any case have only minor effects if the calibration is performed as is described in detail in the following.

If, in this case, calibration is performed on a workpiece at two workpiece width positions, in order to ascertain the axial tilt between the Z1 and C1 axis, it is also irrelevant for the calibration result whether a slightly tilted Z axis or a slightly tilted C1 axis (or both) is present, since at most minimal differences result.

According to a possible embodiment of the present disclosure, the determination of the first and second calibration values (in the x and y/v direction) are performed at the two workpiece width positions z₁ and z₂ for example as follows:

The machining head is displaced via the Z1 axis in such a way that the measuring sensor is located at the first or second workpiece width position z₁ and z₂, respectively.

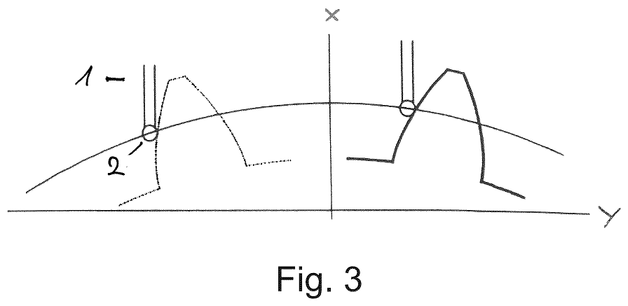

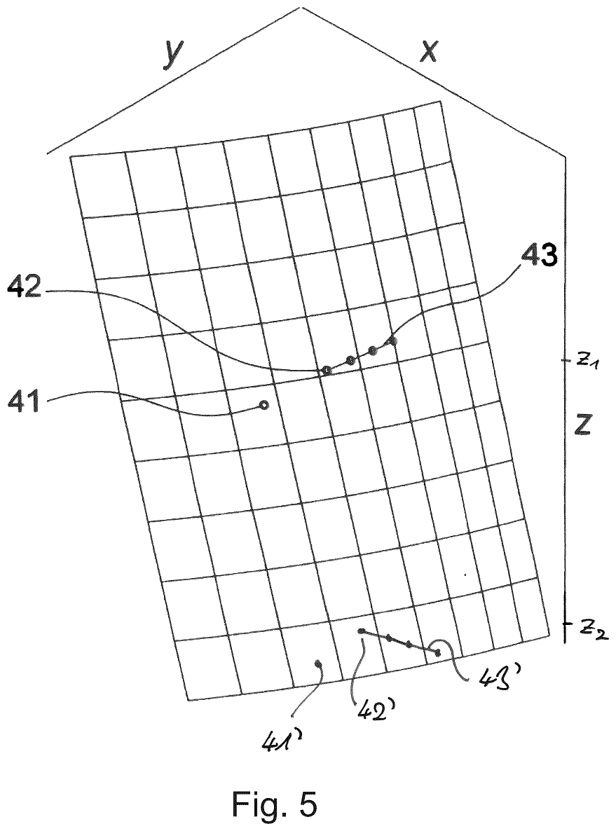

The C1 axis is then rotated and thus the workpiece, apart from the tracer pin, has reached the desired deflection, i.e. preferably such that it has reached half the possible deflection. This situation is shown on the right-hand side in FIG. 3.
The C1 axis is then rotated continuously and the X and Y axes are displaced synchronously, such that if the calibration were perfect the contact point of the measuring sensor tip on the tooth flank and also the magnitude of the sensor deflection remains unchanged, see FIG. 1. In this case, the contact point between the measuring sensor tip and the toothing moves on a circular path, the centre of which is located on the axis of rotation of the toothing.
During this rotation, the deflection of the tracer pin over the C1 angle of rotation is plotted at a plurality of, in particular at as many as possible, discrete points.
This procedure is repeated for the other flank side, such that a deflection representation is achieved for a point on a left-hand flank, and a deflection representation is achieved for a point on a right-hand flank.
If the calibration is perfect and neither the measuring sensor nor the machine axes have any inaccuracies, the plotted deflections of the sensor are in each case constant, for all the C1-positions for the two flanks, in the respective starting sensor deflection. In this case, the contact point of the measuring sensor tip with the two flanks remains unchanged.
If the calibration is not perfect, as shown in FIG. 5 the actual contact point of the measuring sensor tip on the flank at the start of the measurement (42, 42′) does not correspond to the calculated contact point (41, 41′). As a result, the calculated C1 angle which was assumed at the start of the measurement is not reached exactly when the desired deflection of the tracer pin is reached. Furthermore, the deflection of the tracer pin and the contact point on the flank change during displacement of the calculated kinematics paths (43, 43′). If the deflection of the tracer pin is plotted against the C1-position, a curve is obtained for both flanks, respectively.
From this, it is possible to determine first or second calibration value for the X-position and the Y-position of the machining head relative to the axis of rotation C1 for the respectively occupied first or second Z-position z₁ and z₂, respectively.

The determination can in particular take place in each case as is known from DE 10 2019 104 891 A1, wherein the alternatives, described there, to the procedure just described can be implemented. Furthermore, alternatively, it is also possible to determine the first or second calibration values for the X-position and the Y-position of the machining head relative to the axis of rotation C1 for the first or second Z-position z₁ and z₂, respectively, in the manner known from EP 2 554 938 B1.

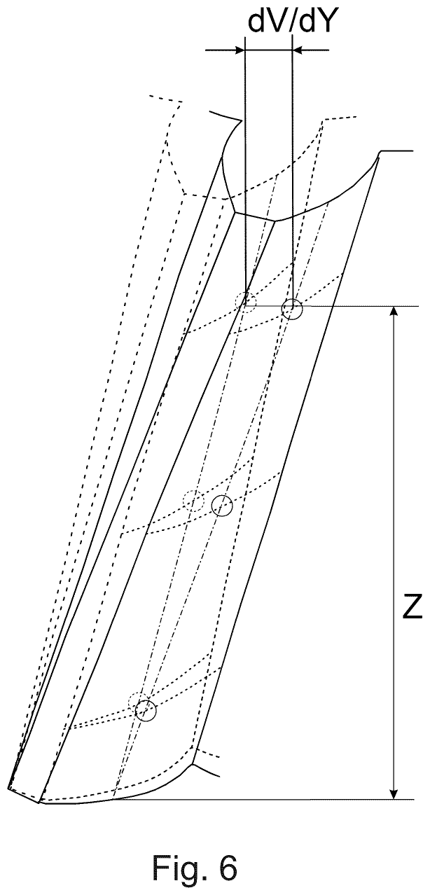

In any case, by calibration at different workpiece width positions, in each case an x- and a y-correction is obtained for said different workpiece width positions from the calibration, which is marked in FIG. 6 for the y-correction as dV/dY. As a result, information regarding the relative position between the C1 (workpiece holder) axis of rotation and Z1 axis of the gear-cutting machine is obtained for different workpiece width positions.

In this case, in the example in FIGS. 4, 6 and 7, calibration was performed at three different workpiece width positions or Z-positions, and for this in each case calibration values for the X1 axis and the V1/Y1 axis were determined.

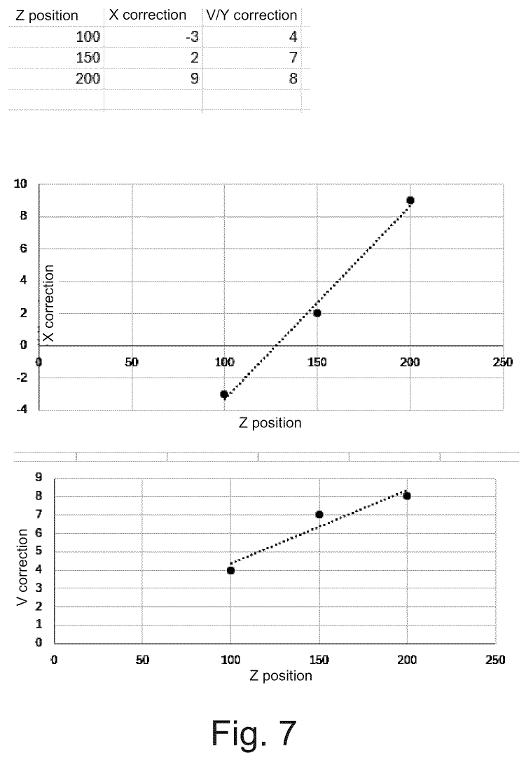

A line of best fit can be plotted in each case through these calibration values, as is shown by way of example in FIG. 7. In this case, the thick points are the calibration values at the measuring points, the dashed line is a line of best fit/trendline.

The pitch of the line of best fit thus constitutes a third calibration value, which describes the tilt of the C1 and Z1 axis relative to one another and can be used for the compensation thereof.

The line of best fit can now be linearly extrapolated to the entire Z displacement range of the machine, such that compensation curves result.

In a first variant, for correcting the tilts, both during machining and during measuring/checking in the machine, during displacement of the Z axis, depending on the Z-position, the X1 and the V1/Y1 axis can also be displaced therewith along the compensation curves.

For example, if the Z1 axis is displaced from position 110 to the position 140 in FIG. 7, without in this case wishing to change the relative position in the X1 and V1/Y1 direction, the machine automatically changes the X1-position by +3 and the V1-position by +1 (along the compensation curve) during displacement.

This can make it possible that a machining tool/a measuring sensor can be displaced exactly in parallel with C1, in Z1. Thus, an error due to axial tilts does not arise either during machining or during measuring.

Therefore, in a final expansion stage all that remains necessary is to calculate the compensation curve from the calibration results and to actuate the machine accordingly.

If it is not possible or not wished to travel any compensation curves in which X1 and V1 are additionally displaced, in a manner dependent on Z1, along the compensation curves, for example since this cannot be directly implemented in the machine controller, a further possibility consists in calculating an offset on the flank line angle for the right-hand and left-hand flank in each case, for a flank line measurement in the machine, from the pitch of the compensation curve. If the measuring sensor now measures a flank line, this offset must be added to the fHbeta of the right-hand and left-hand flank. Likewise, offsets for the specification of the fHbeta modification could also be calculated for the machining method, such that this compensates the axial tilts. The offsets for the measurement are dependent on the X-position of the measuring sensor during the flank line measurement, and the offsets for the machining depend on the machining method. They are therefore not necessarily the same.

If the accuracy is intended to be further improved, because for example the conicity of the workpiece due to an axial tilt in the X direction is not taken into account sufficiently precisely, it would be conceivable to perform a significantly more complex calculation. In the case of the procedure described above, the evaluation calculation of the calibration includes only the calibration in a profile height on the right-hand and left-hand flank, form which an X and a V correction is calculated. A further calculation/evaluation can include calibration measurements at different profile heights.

Therefore, according to this procedure, for example by
a first calibration with the contact point on SAP and
a second calibration with the contact point on EAP
mechanical errors when travelling on the entire profile (in the case of a calibration of the sensor between SAP and EAP) can be ascertained and largely eliminated.

However, what is decisive for the present disclosure is the calibration via the workpiece width, regarding which yet further embodiments of the present disclosure will be set out in the following.

In the case of the measurement of the flank line, as set out above the essential problem exists that the axial parallelism of the lifting axis Z1 relative to the workpiece holder axis C1 is hitherto measured and optionally compensated only in the context of commissioning.

Therefore, in present disclosure,
a first calibration is performed in the upper flank line region (e.g. 10% of the workpiece width) and
a second calibration is performed in the lower flank line region (e.g. 90% of the workpiece width),
and thus the mechanical errors when travelling over the entire flank line (with calibration at e.g. 50%) is ascertained and eliminated as far as possible.

In this case, the respective calibrations in each case ascertain an offset in X and Y of the measuring sensor—in absolute terms with respect to the workpiece axis of rotation C1.

Thus, by carrying out the calibrations at different toothing width positions, for example in the vicinity of the two end faces, the mechatronic inaccuracy of the topmost to the bottommost point of the flank line measurement can be ascertained, and thus the mechatronically “inaccurately” measured f_H-beta can be corrected.

It is thus possible to bring the workpiece checks on a production machine closer to the accuracy of a measuring machine, since the additional calibrations before the actual measurement of the current geometric state of the machine (which can change in particular due to thermal effects) is recorded.

Thus, in particular for flank line angle measurements, new levels of accuracy hitherto not conceivable for a production machine can result since the axial position dependency of the lifting axis Z1 relative to the workpiece holder axis C1 is largely eliminated.

For the calibration, the gearwheel currently located in the work space can be used:
before the machining
during the machining (between machining rounds)
after the machining.

In this way, the parallelism of the lifting axis Z1 (or the position of the sensor) relative to the bench axis of rotation C1 can be recorded, in order to
correct the specification for the kinematics before the start of the machining
correct the specification for the kinematics during the machining
to correct the measurement after the machining (in advance, retrospectively).

The toothing machining is preferably hard-fine machining, for which there are corresponding accuracy requirements, but may also be machining by other methods such as milling, gear skiving or knocking.

The behaviour of the machining device can be better understood or predefined from the f_H_beta calibrations in connection with temperature measurements or other correction measurements (AMC). A corresponding verification would also be possible after the machining.

Note: AMC=automatic X-correction after measurement with a measuring sensor on the workpiece or a measuring surface on the counterhold

What is decisive for a control calibration during the machining is that the thermal (geometric) damage that results by the interruption of the machining process is not greater than the perceived gain in accuracy by the calibration. This influence could optionally also be better estimated and predetermined by continuous learning in various machining processes.

The calibration method is in each case based on the fact that the workpiece is rotated: the rotational position can be recorded highly accurately using the typically installed transducer. This also applies for the case of a helical toothing, in the case of which a twisting of the workpiece must be superimposed, depending on the lifting position. The actual position of the sensor relative to the table axis is the sum of thermal and mechatronic deviations of the axes and components involved: optionally, varying degrees of influences from involved axes and components can be concluded from different kinematics during calibration (e.g. purely tangential movement by V1 in combination with C1, compared with a combined movement of V1 and X1 and C1.

If it is possible to determine the position of the sensor relative to the table axis, then other, further calibration measurements, such as AMC on the counterhold can thus be newly interpreted since a displacement of the counterhold relative to the table axis can be ascertained thereby. If this exceeds allowable limit values e.g. in the case of a control calibration during the machining, the process can be interrupted in order to realign the counterhold tip. Thus, scrap could be prevented, although of course with the risk that the thermal (geometric) damage resulting from the interruption in the machining process is not already greater than the perceived gain in accuracy from the calibration/readjustment.

1. A method for calibrating a gear-cutting machine, which comprises a workpiece holder that is rotatable about a first axis of rotation C1, a machining head comprising a tool holder, and a sensor for measuring a workpiece that is held in the workpiece holder of the gear-cutting machine, wherein the sensor is arranged on the machining head of the gear-cutting machine, wherein the machining head is displaceable relative to the workpiece holder in the workpiece width direction via a first linear movement axis Z of the gear-cutting machine, and
wherein the method comprises the following steps of:
ascertaining at least one first calibration value by measuring a toothing of the workpiece at a first workpiece width position,
ascertaining at least one second calibration value by measuring the toothing of the workpiece at a second workpiece width position, and
determining at least one third calibration value for the relative orientation of the first linear movement axis Z of the machining head with respect to the first axis of rotation C1 of the workpiece holder from the at least one first and the at least one second calibration value.

2. The method according to claim 1, wherein the gear-cutting machine comprises at least one second linear axis X1 and/or one third linear axis V1/Y1 for displacing the machining head relative to the workpiece holder, wherein the at least one first calibration value and the at least one second calibration value relate in each case to a calibration of the position of the second linear axis X1 and/or of the third linear axis V1/Y1 relative to the first axis of rotation C1.

3. The method according to claim 1, wherein the toothing is produced before the measurement in the same clamping operation on the gear-cutting machine, or wherein the toothing is already present before clamping of the workpiece in the gear-cutting machine and no machining of the toothing on the gear-cutting machine takes place before the measurement of the toothing.

4. The method according to claim 1, wherein the ascertaining of the at least one first and second calibration value takes place in each case by ascertaining at least one relative position, determined via the sensor, between the workpiece and the machining head at at least one measuring point, and the ascertained result is compared with a target relative position, in order to determine therefrom a correction value.

5. The method according to claim 1, wherein the ascertaining of the at least one first calibration value and of the at least one second calibration value takes place in that the workpiece is rotated, for the measurement, about the axis of rotation C1 of the workpiece holder, and the sensor is displaced via at least one axis of the gear-cutting machine in order to measure the toothing.

6. The method according to claim 5, wherein a measuring point of the sensor is guided in two measurement runs along two different paths along the surface of the toothing, and the first or second calibration value is determined from deviations between the measurement results.

7. The method according to claim 5, wherein the sensor is displaced such that a measuring point on the tooth flank would remain unchanged in the case of perfect calibration, wherein the first or second calibration value are determined from deviations between a displacement movement of the sensor expected in the case of perfect calibration and/or a sensor value expected in the case of perfect calibration, and an actual displacement movement of the sensor and/or an actual sensor value in the determination.

8. The method according to claim 1, wherein the sensor is a measuring sensor.

9. The method according to claim 1, wherein at least the third calibration value is consulted, in a subsequent measurement and/or machining, for correcting the displacement kinematics of the machining head and/or for correcting the measurement and/or actuation values.

10. The method according to claim 2, wherein in the case of a subsequent measurement and/or machining, during displacement of the machining head along the first linear movement axis Z depending on the position in the workpiece width direction, the second linear axis X and/or the third linear axis V/Y is also displaced depending on the third calibration value.

11. The method according to claim 1, wherein in the case of a subsequent measurement and/or machining a target flank line angle that is measured and/or on which the actuation is based is corrected depending on the third calibration value.

12. The method according to claim 1, wherein the calibration takes place between two machining steps on the workpiece, or wherein the calibration takes place after the machining of the workpiece.

13. The method according to claim 1, wherein in order to determine the at least one third calibration value, calibration values are ascertained at three or more workpiece width positions by measuring the workpiece.

14. A gear-cutting machine, which comprises a workpiece holder that is rotatable about a first axis of rotation C1, a machining head comprising a tool holder, and a sensor for measuring a workpiece that is held in the workpiece holder of the gear-cutting machine, wherein the sensor is arranged on the machining head of the gear-cutting machine, wherein the machining head is displaceable relative to the workpiece holder in the workpiece width direction via a first linear movement axis Z of the gear-cutting machine,
wherein the gear-cutting machine comprises a controller which is configured and/or programmed to carry out the method according to claim 1 on the gear-cutting machine,
wherein the controller performs the individual steps of the method automatically and/or has operator guidance for performing the steps.

15. A software programme for control of a gear-cutting machine comprising commands which carry out the method according to claim 1 on the gear-cutting machine, when executed on a controller,
wherein the gear-cutting machine performs the individual steps of the method automatically with actuation by the software programme, and/or has operator guidance for performing the steps.

16. The method according to claim 5, wherein the sensor for measuring the workpiece is guided on at least one predetermined path with respect to a point on the workpiece surface.

17. The method according to claim 11, wherein the correction is performed via an offset that is dependent on the third calibration value.
